(19) United States
(12) Patent Application Publication
(10) Pub. No.: US 2017/0041272 A1
(43) Pub. Date: Feb. 9, 2017

(54) ELECTRONIC DEVICE AND METHOD FOR TRANSMITTING AND RECEIVING CONTENT

(71) Applicant: Samsung Electronics Co., Ltd., Gyeonggi-do (KR)

(72) Inventors: Hye-Jung CHANG, Seoul (KR); Giang-Yoon KWON, Seoul (KR); Ki-Hyoung SON, Gyeonggi-do (KR); Kyung-Jun LEE, Gyeonggi-do (KR); Hyun-Yeul LEE, Seoul (KR); Seung-Yeon CHUNG, Seoul (KR)

(21) Appl. No.: 15/231,199

(22) Filed: Aug. 8, 2016

(30) Foreign Application Priority Data
Aug. 6, 2015 (KR) 10-2015-0110996

(51) Int. Cl. H04L 12/58; G06F 3/0488; G06K 9/00

(52) U.S. Cl. CPC H04L 51/18; H04L 51/08; H04L 51/04; H04L 51/38; G06K 9/00228; G06F 3/0488

(57) ABSTRACT

Disclosed is a method for transmitting and receiving content in an electronic device. The method includes executing a message application, transmitting, if content to be transmitted is selected, the selected content by using the executed message application, and displaying an emoticon replacing the transmitted content on the executed message application.

### PRIORITY

This application claims priority under 35 U.S.C. §119(a) to a Korean Patent Application filed in the Korean Intellectual Property Office on Aug. 6, 2015 and assigned Serial No. 10-2015-0110996, the contents of which are incorporated herein by reference.

### BACKGROUND

1. Field of the Disclosure

The present disclosure relates generally to an electronic device, and more particularly, to an electronic device and method for transmitting and receiving content.

2. Description of the Related Art

A variety of services and additional functions provided in electronic devices have been gradually expanded. Various applications for the electronic devices have been developed to increase the utility value of the electronic devices and to satisfy various needs of the users.

Accordingly, in recent years, hundreds of applications and a program capable of playing or displaying a variety of content have been developed to be stored in mobile electronic devices equipped with a touch screen, such as smart phones, cell phones, notebook personal computers (PCs) and tablet PCs. The user may not only express a variety of emotions, but also, may transfer content to another party and watch desired content on these electronic devices.

Conventionally, when desiring to share feelings about the content with other people, the user separately transfers the content and the text representing the user's feeling.

In other words, when transferring the feelings about the content in the conventional art, the user may transfer a text or icon representing the feeling after sending the content, or may transfer the content after transferring a text or icon representing the feeling. As such, by separately transferring the content and the text or icon representing the feeling, the user has to inconveniently re-transfer information about the feeling using the text or icon each time the user feels an emotion about the content.

Therefore, as an effect corresponding to an emotion of the user watching the content is applied to the content and the emotion effect-applied content is transferred, there is a need in the art for a method for a user receiving the content to be able to identify the emotion of the user that has transferred the content. In addition, there is a need in the art for a method to exchange the emotion effects with the other party in real time by connecting a sympathetic channel capable of transmitting and receiving the emotion effects.

### SUMMARY

The present disclosure has been made to address at least the above-mentioned problems and/or disadvantages and to provide at least the advantages described below.

Accordingly, an aspect of the present disclosure is to provide an electronic device and method for transmitting and receiving content.

Another aspect of the present disclosure is to provide a method in which a user receiving content may identify the emotion of the user that has transferred the content.

In accordance with an aspect of the present disclosure, there is provided a method for transmitting and receiving content in an electronic device, including executing a message application, transmitting, if content to be transmitted is selected, the selected content by using the executed message application, and displaying an emoticon replacing the transmitted content on the executed message application.

In accordance with another aspect of the present disclosure, there is provided a method for transmitting and receiving content in an electronic device, including receiving a message including content to which an emotion effect is applied, displaying information about a sender who has sent the message and an emotion level of the emotion effect, and displaying the emotion effect-applied content in response to a check of the received message.

In accordance with another aspect of the present disclosure, there is provided an electronic device for transmitting and receiving content, including a display configured to display a message application, and a controller configured to execute the message application, transmit, if content to be transmitted is selected, the selected content by using the executed message application, and display an emoticon replacing the transmitted content on the executed message application.

### BRIEF DESCRIPTION OF THE DRAWINGS

The above and other aspects, features and advantages of certain embodiments of the present disclosure will be more apparent from the following description taken in conjunction with the accompanying drawings, in which:

FIG. 1 illustrates an electronic device in a network environment according to embodiments of the present disclosure;

FIG. 2 is a block diagram of an electronic device according to embodiments of the present disclosure;

FIG. 3 is a block diagram of a program module according to embodiments of the present disclosure;

FIG. 4 is a block diagram illustrating an electronic device that displays an emotion effect on the displayed content according to embodiments of the present disclosure;

FIG. 5 illustrates a process of receiving content according to embodiments of the present disclosure;

FIG. 6A illustrates the reception of a message including content according to embodiments of the present disclosure;

FIG. 6B illustrates the check of a message including content according to embodiments of the present disclosure;

FIG. 6C illustrates the display of a message including content according to embodiments of the present disclosure;

FIG. 7 illustrates a process of transmitting content according to embodiments of the present disclosure;

FIG. 8A illustrates the transmission of a message through an application according to embodiments of the present disclosure;

FIG. 8B illustrates the selection of emotion effect-applied content according to embodiments of the present disclosure;

FIG. 8C illustrates the transmission of emotion effect-applied content according to embodiments of the present disclosure;

FIG. 8D illustrates the display of an emoticon replacing the content according to embodiments of the present disclosure;

FIG. 9A illustrates the reception of an emoticon replacing the content according to embodiments of the present disclosure;

FIG. 9B illustrates the playback of an emotion effect by the selection of the received content according to embodiments of the present disclosure;

FIG. 9C illustrates the display of the emotion effect on an application after completion of the playback of the emotion effect according to embodiments of the present disclosure;

FIG. 10 illustrates a process of transmitting and receiving content according to embodiments of the present disclosure;

FIG. 11A illustrates a screen of a first electronic device according to embodiments of the present disclosure;

FIG. 11B illustrates a screen of a second electronic device according to embodiments of the present disclosure;

FIG. 12 illustrates a process of grouping senders who have sent emotion effect-applied content, according to embodiments of the present disclosure; and

FIG. 13 illustrates the display of the grouped senders who have sent emotion effect-applied content, according to embodiments of the present disclosure.

Throughout the drawings, like reference numerals will be understood to refer to like parts, components, and structures.

### DETAILED DESCRIPTION OF EMBODIMENTS OF THE DISCLOSURE

Hereinafter, embodiments of the present disclosure will be described with reference to the accompanying drawings. However, the present disclosure is not intended to be limited to particular embodiments, and thus should be construed as including various modifications, equivalents, and/or alternatives according to the embodiments of the present disclosure. In regard to the description of the drawings, like reference numerals refer to like elements.

In the present disclosure, expressions such as “having,” “may have,” “comprising,” and “may comprise” indicate existence of a corresponding characteristic, and do not exclude the existence of an additional characteristic.

In the present disclosure, expressions such as “A or B,” “at least one of A or/and B,” and “one or more of A or/and B” may include all possible combinations of the together listed items. For example, “A or B,” “at least one of A and B,” and “one or more of A or B” may indicate any of (1) including at least one A, (2) including at least one B, and (3) including both at least one A and at least one B.

Expressions such as “first,” “second,” “primarily,” or “secondary,” used in various embodiments may represent various elements regardless of order and/or importance and do not limit corresponding elements. The expressions may be used for distinguishing one element from another element. For example, a first user device and a second user device may represent different user devices regardless of order or importance. A first element may be referred to as a second element without deviating from the scope of the present disclosure, and similarly, a second element may be referred to as a first element.

When it is described that an element, such as a first element, is operatively or communicatively coupled to or connected to another element, such as a second element, the first element can be directly connected to the second element or can be connected to the second element through a third element. However, when it is described that the first element is directly connected or directly coupled to the second element, there is no intermediate third element between the first and second elements.

An expression “configured to” used in the present disclosure may be used interchangeably with “suitable for,” “having the capacity to,” “designed to,” “adapted to,” “made to,” or “capable of” according to the situation. The expression “configured to (or set)” does not always indicate only “specifically designed to” by hardware. Alternatively, in some situations, an expression “apparatus configured to” may indicate that the apparatus “can” operate together with another apparatus or component. For example, a phrase “a processor configured (or set) to perform A, B, and C” may be a generic-purpose processor, such as a central processing unit (CPU) or an application processor that can perform a corresponding operation by executing at least one software program stored at an embedded processor for performing a corresponding operation or at a memory device.

Terms defined in the present disclosure are used for only describing a specific embodiment and are not intended to limit the scope of other embodiments. When using in a description of the present disclosure and the appended claims, a singular form may include a plurality of forms unless it is explicitly differently represented. Entire terms including a technical term and a scientific term used here may have the same meaning as a meaning that may be generally understood by a person of common skill in the art. Terms defined in general dictionaries among terms used herein have the same or similar meaning as that of a context of related technology and are not analyzed as an ideal or excessively formal meaning unless explicitly defined. In some case, terms defined in the present disclosure cannot be analyzed to exclude the present embodiments.

An electronic device according to embodiments of the present disclosure includes at least one of a smart phone, a tablet PC, a mobile phone, a video phone, an e-book reader, a desktop PC, a laptop PC, a netbook computer, a workstation, a server, a personal digital assistant (PDA), a portable multimedia player (PMP), a motion pictures experts group (MPEG) layer audio 3 (MP3) player, a mobile medical device, a camera, and a wearable device. In embodiments, the wearable device includes at least one of an accessory-type wearable device, such as a watch, a ring, a bracelet, an anklet, a necklace, glasses, a contact lens, or a head mounted device (HMD), a fabric/clothing-integrated wearable device, such as electronic clothing, a body-mounted wearable device, such as a skin pad or tattoo, or a bio-implantable wearable device, such as an implantable circuit.

In embodiments, the electronic device may be a home appliance, such as a television (TV), a digital video disk (DVD) player, an audio player, a refrigerator, an air conditioner, a cleaner, an oven, a microwave oven, a washer, an air purifier, a set-top box, a home automation control panel, a security control panel, a TV box, such as a Samsung HomeSync™, an Apple TV™, or a Google TV™, a gaming console, such as Xbox™ or PlayStation™, an electronic dictionary, an electronic key, a camcorder or a digital photo frame.

In another embodiment, the electronic device includes at least one of various medical devices, such as a blood glucose meter, a heart rate meter, a blood pressure meter, or a body temperature meter, a magnetic resonance angiography (MRA) device, a magnetic resonance imaging (MRI) device, a computed tomography (CT) device, a medical camcorder, or an ultrasonic device, a navigation device, a global navigation satellite system (GNSS), an event data recorder (EDR), a flight data recorder (FDR), an automotive infotainment device, a marine electronic device, such as a marine navigation device, or a gyro compass, avionics, a security device, a car head unit, an industrial or household robot, an automated teller machine (ATM), point of sales (POS) device for shops, or an Internet of Things (IoT) device, such as an electric bulb, various sensors, an electricity or gas meter, a sprinkler device, a fire alarm, a thermostat, a streetlamp, a toaster, fitness equipment, a hot water tank, a heater, and a boiler.

In some embodiments, the electronic device includes at least one of a part of the furniture or building/structure, an electronic board, an electronic signature receiving device, a projector, or various meters, such as for water, electricity, gas or radio waves. The electronic device may be one or a combination of the above-described various devices, and may be a flexible electronic device. An electronic device according to an embodiment of the present disclosure will not be limited to the above-described devices, and may include a new electronic device provided in the future by the development of technology.

As used herein, the term “user” may refer to a person who uses the electronic device, or a device such as an intelligent electronic device that uses the electronic device.

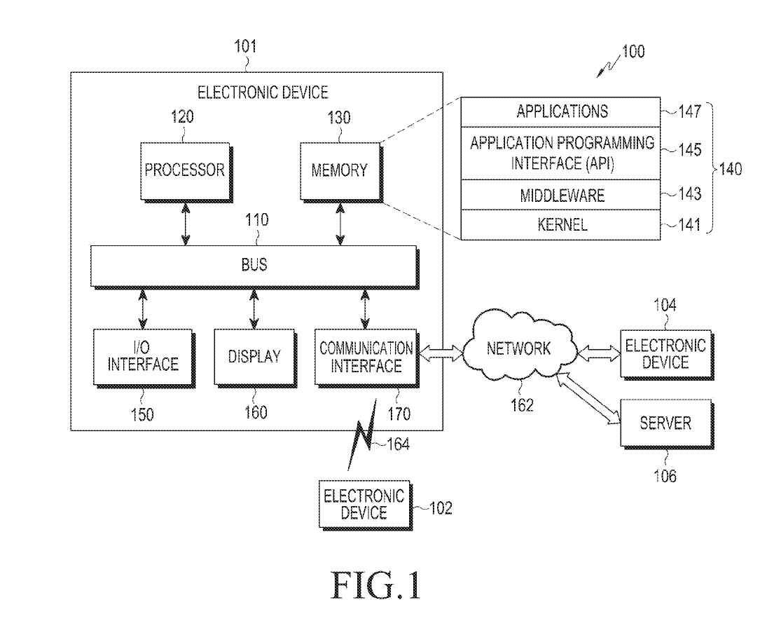

FIG. 1 illustrates an electronic device 101 in a network environment 100 according to embodiments of the present disclosure.

The electronic device 101 includes a bus 110, a processor 120, a memory 130, an input/output (I/O) interface 150, a display 160 and a communication interface 170. In some embodiments, the electronic device 101 may omit at least one of the components, or may additionally include other embodiments.

The bus 110 includes a circuit that connects the components 110 to 170 to each other, and transfers the communication, such as a control message and/or data between the components 110 to 170.

The processor 120 includes at least one of a central processing unit (CPU), an application processor (AP) and a communication processor (CP). The processor 120 may execute a control and/or communication-related operation or data processing for at least one other component of the electronic device 101.

The memory 130 includes a volatile and/or non-volatile memory. The memory 130 may store a command or data related to at least one other component of the electronic device 101. In one embodiment, the memory 130 may store software and/or a program 140. The program 140 includes a kernel 141, a middleware 143, an application programming interface (API) 145, and/or applications 147. At least two of the kernel 141, the middleware 143 and the API 145 may be referred to as an operating system (OS).

The kernel 141 may control or manage the system resources, such as the bus 110, the processor 120, and the memory 130 that are used to execute the operation or function implemented in other programs, such as the middleware 143, the API 145, or the applications 147. The kernel 141 may provide an interface by which the middleware 143, the API 145 or the applications 147 can control or manage the system resources by accessing the individual components of the electronic device 101.

The middleware 143 may perform an intermediary role so that the API 145 or the applications 147 may exchange data with the kernel 141 by communicating with the kernel 141. The middleware 143 processes work requests received from the applications 147 according to their priority. For example, the middleware 143 may give a priority to use the system resources, such as the bus 110, the processor 120, or the memory 130 of the electronic device 101, to at least one of the applications 147. For example, the middleware 143 processes the work requests according to the priority given to at least one of the applications 147, thereby performing scheduling or load balancing for the work requests.

The API 145 is an interface by which the applications 147 control the function provided in the kernel 141 or the middleware 143, and includes at least one interface or function for file control, window control, image processing or character control

The I/O interface 150 may serve as an interface that can transfer a command or data received from the user or other external devices to the other components of the electronic device 101. The I/O interface 150 outputs a command or data received from the other components of the electronic device 101, to the user or other external devices.

The display 160 includes a liquid crystal display (LCD) display, a light emitting diode (LED) display, an organic light emitting diode (OLED) display, a micro-electromechanical systems (MEMS) display, or an electronic paper display. The display 160 may display a variety of content, such as texts, images, videos, icons, or symbols, for the user, includes a touch screen, and receives a touch input, a gesture input, a proximity input or a hovering input made by an electronic pen or a part of the user's body.

The communication interface 170 may establish communication between the electronic device 101 and an external device, such as a first external electronic device 102, a second external electronic device 104 or a server 106. For example, the communication interface 170 communicates with the external device by being connected to a network 162 through wireless communication or wired communication.

The wireless communication includes at least one of long term evolution (LTE), long term evolution-advanced (LTE-A), code division multiple access (CDMA), wideband code division multiple access (WCDMA), universal mobile telecommunications system (UMTS), wireless broadband (WiBro) and global system for mobile communications (GSM), as a cellular communication protocol. The wireless communication includes, short-range communication 164. The short-range communication 164 includes at least one of, wireless fidelity (WiFi), Bluetooth™, near field communication (NFC) or global navigation satellite system (GNSS). GNSS includes at least one of, global positioning system (GPS), global navigation satellite system (Glonass), navigation satellite system (Beidou or Galileo), or the European global satellite-based navigation system depending on the use area or the bandwidth. Herein, “GPS” may be interchangeably used with “GNSS”. The wired communication includes at least one of universal serial bus (USB), high definition multimedia interface (HDMI), recommended standard 232 (RS-232) and plain old telephone service (POTS). The network 162 includes a telecommunications network, such as a local area network (LAN) or a wide area network (WAN), the Internet, or the telephone network.

Each of the first and second external electronic devices 102 and 104 may or may not be identical in type to the electronic device 101. In one embodiment, the server 106 includes a group of one or more servers. All or some of the operations executed in the electronic device 101 may be executed in one or multiple other electronic devices, such as the electronic devices 102 and 104 or the server 106. When the electronic device 101 should perform a certain function or service automatically or upon request, the electronic device 101 may send a request for at least some of the functions related thereto to other electronic devices, such as the electronic devices 102 and 104 or the server 106, instead of or in addition to spontaneously executing the function or service. The other electronic devices may execute the requested function or additional function, and transfer the results to the electronic device 101. The electronic device 101 processes the received results intact or additionally, to provide the requested function or service. To this end, the cloud computing, distributed computing, or client-server computing technology may be used.

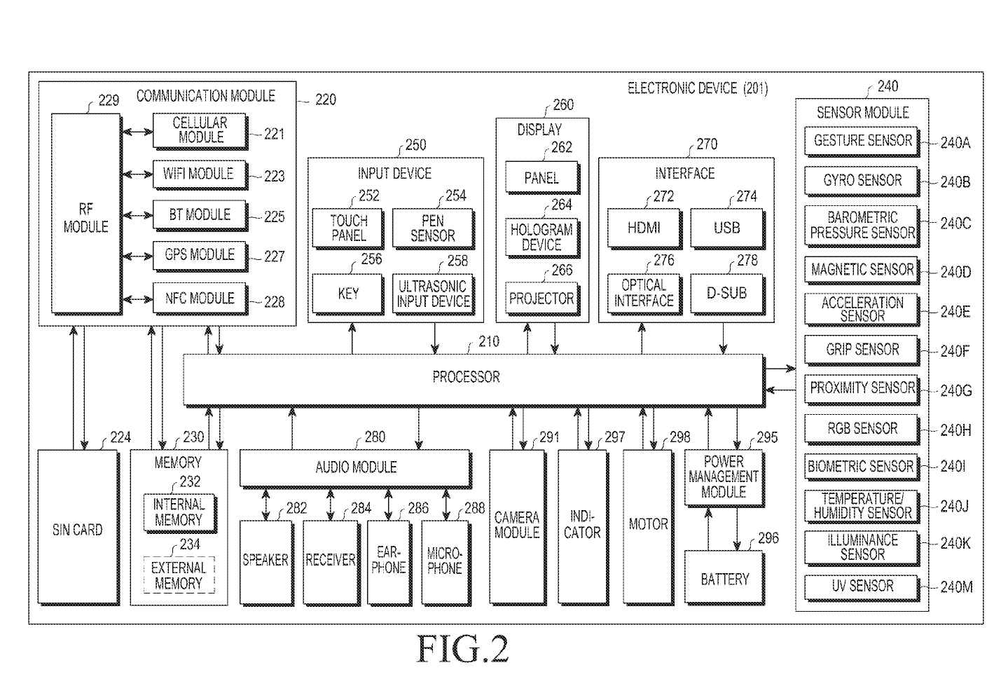

FIG. 2 is a block diagram of an electronic device 201 according to embodiments of the present disclosure.

An electronic device 201 includes all or a part of the electronic device 101 shown in FIG. 1. The electronic device 201 includes at least one of an application processor (AP)) 210, a communication module 220, a subscriber identification module (SIM) card 224, a memory 230, a sensor module 240, an input device 250, a display 260, an interface 270, an audio module 280, a camera module 291, a power management module 295, a battery 296, an indicator 297 and a motor 298.

The processor 210 may control a plurality of hardware or software components connected to the processor 210 by executing the operating system or application program, and processes and compute a variety of data. The processor 210 may be implemented in a system on chip (SoC), and may further include a graphic processing unit (GPU) and/or an image signal processor (ISP). The processor 210 loads, on a volatile memory, a command or data received from at least one of other components, such as a non-volatile memory, processes the loaded data, and stores a variety of data in a non-volatile memory.

The communication module 220 may be identical or similar in structure to the communication interface 170 in FIG. 1. The communication module 220 includes, a cellular module 221, a WiFi module 223, a Bluetooth (BT) module 225, a GNSS module 227, such as a GPS module, a Glonass module, a Beidou module or a Galileo module, an NFC module 228, and a radio frequency (RF) module 229.

The cellular module 221 may provide a voice call service, a video call service, a messaging service or an Internet service over a communication network. The cellular module 221 performs identification and authentication for the electronic device 201 within the communication network using the subscriber identification module (SIM) card 224, performs at least some of the functions that can be provided by the processor 210 and includes a communication processor (CP).

Each of the WiFi module 223, the BT module 225, the GNSS module 227 or the NFC module 228 includes a processor for processing the data transmitted or received through the corresponding module. In some embodiments, at least two of the cellular module 221, WiFi module 223, the BT module 225, the GNSS module 227 and the NFC module 228 may be included in one integrated chip (IC) or IC package.

The RF module 229 transmits and receives communication signals, such as radio frequency (RF) signals. The RF module 229 includes a transceiver, a power amplifier module (PAM), a frequency filter, a low noise amplifier (LNA), or an antenna. In another embodiment, at least one of the cellular module 221, the WiFi module 223, the BT module 225, the GNSS module 227 or the NFC module 228 transmits and receives RF signals through a separate RF module.

The SIM 224 includes, a card with a SIM and/or an embedded SIM, and further includes unique identification information, such as an integrated circuit card identifier (ICCID) or subscriber information, such as international mobile subscriber identity (IMSI).

The memory 230 includes an internal memory 232 or an external memory 234. The internal memory 232 includes at least one of a volatile memory, such as dynamic RAM (DRAM), static RAM (SRAM), and synchronous dynamic RAM (SDRAM), or a non-volatile memory, such as one time programmable ROM (OTPROM), programmable ROM (PROM), erasable and programmable ROM (EPROM), electrically erasable and programmable ROM (EEPROM), mask ROM, flash ROM, flash memory, such as a NAND or NOR flash, hard drive, or solid state drive (SSD).

The external memory 234 may further include a flash drive such as compact flash (CF), secure digital (SD), micro secure digital (Micro-SD), mini secure digital (Mini-SD), extreme digital (xD), a multi-media card (MMC), or a memory stick. The external memory 234 may be functionally and/or physically connected to the electronic device 201 through various interfaces.

The sensor module 240 may measure the physical quantity or detect the operating status of the electronic device 201, and convert the measured or detected information into an electrical signal. The sensor module 240 includes at least one of a gesture sensor 240A, a gyro sensor 240B, a barometric pressure sensor 240C, a magnetic sensor 240D, an acceleration sensor 240E, a grip sensor 240F, a proximity sensor 240G, a color sensor, such as red-green-blue (RGB) sensor 240H, a biometric sensor 240I, a temperature/humidity sensor 240J, an illuminance sensor 240K, or an ultra violet (UV) sensor 240M. Additionally or alternatively, the sensor module 240 may include an E-nose sensor, an electromyography (EMG) sensor, an electroencephalogram (EEG) sensor, an electrocardiogram (ECG) sensor, an infrared (IR) sensor, an iris sensor and/or a fingerprint sensor. The sensor module 240 may further include a control circuit for controlling at least one or more sensors belonging thereto. In some embodiments, the electronic device 201 may further include a processor configured to control the sensor module 240, independently of or as a part of the processor 210, to control the sensor module 240 while the processor 210 is in a sleep state.

The input device 250 includes a touch panel 252, a (digital) pen sensor 254, a key 256, or an ultrasonic input device 258. The touch panel 252 may use at least one of the capacitive, resistive, infrared or ultrasonic schemes, and further include a control circuit and a tactile layer that provides a tactile or haptic feedback to the user.

The (digital) pen sensor 254 may be a part of the touch panel 252, or includes a separate recognition sheet. The key 256 includes a physical button, an optical key or a keypad. The ultrasonic input device 258 may detect ultrasonic waves generated in an input tool using a microphone 288, to identify the data corresponding to the detected ultrasonic waves.

The display 260 includes a panel 262, a hologram device 264, and a projector 266. The panel 262 may be identical or similar in structure to the display 160 in FIG. 1. The panel 262 may be implemented to be flexible, transparent or wearable, and together with the touch panel 252, may be implemented as one module. The hologram device 264 displays stereoscopic images in the air using the interference of the light. The projector 266 displays images by projecting the light onto the screen. The screen may be disposed on the inside or outside of the electronic device 201. In one embodiment, the display 260 may further include a control circuit for controlling the panel 262, the hologram device 264, or the projector 266.

The interface 270 includes a high definition multimedia interface (HDMI) 272, a USB 274, an optical interface 276 or a D-subminiature (D-sub) 278. The interface 270 may be included in the communication interface 170 shown in FIG. 1. Additionally or alternatively, the interface 270 includes a mobile high-definition link (MHL) interface, a secure digital (SD) card/multi-media card (MMC) interface or an infrared data association (IrDA) interface.

The audio module 280 may convert the sounds and the electrical signals bi-directionally. At least some components of the audio module 280 may be included in the I/O interface 150 shown in FIG. 1. The audio module 280 may process the sound information that is received or output through a speaker 282, a receiver 284, an earphone 286 or the microphone 288.

The camera module 291 is capable of capturing still images and videos. In one embodiment, the camera module 291 includes one or more image sensors, such as a front image sensor or a rear image sensor, a lens, an image signal processor (ISP), or a flash, such as a light emitting diode (LED) or xenon lamp.

The power management module 295 manages the power of the electronic device 201, which is supplied with the power via a battery, but the present disclosure is not limited thereto. In one embodiment, the power management module 295 includes a power management integrated circuit (PMIC), a charger integrated circuit (IC), or a battery gauge. The PMIC may have wired and/or wireless charging schemes. The wireless charging scheme includes a magnetic resonance scheme, a magnetic induction scheme, or an electromagnetic scheme, and the power management module 295 may further include additional circuits, such as a coil loop, a resonant circuit, or a rectifier, for wireless charging. The battery gauge may measure the remaining capacity, charging voltage, charging current or temperature of the battery 296. The battery 296 includes a rechargeable battery and/or a solar battery.

The indicator 297 may indicate specific status, such as boot, message, or charging status of the electronic device 201 or a part (e.g. the processor 210) thereof. The motor 298 may convert an electrical signal into mechanical vibrations to generate a vibration or haptic effect. The electronic device 201 includes a processing device, such as GPU) for mobile TV support, which processes the media data that is based on the standards such as digital multimedia broadcasting (DMB), digital video broadcasting (DVB) or MediaFLO™.

Each of the components described herein may be configured with one or more components, names of which may vary depending on the type of the electronic device. In embodiments, the electronic device includes at least one of the components described herein, some of which may be omitted, or may further include additional other components. Some of the components of the electronic device according to embodiments of the present disclosure may be configured as one entity by being combined, thereby performing the functions of the components before being combined, in the same manner.

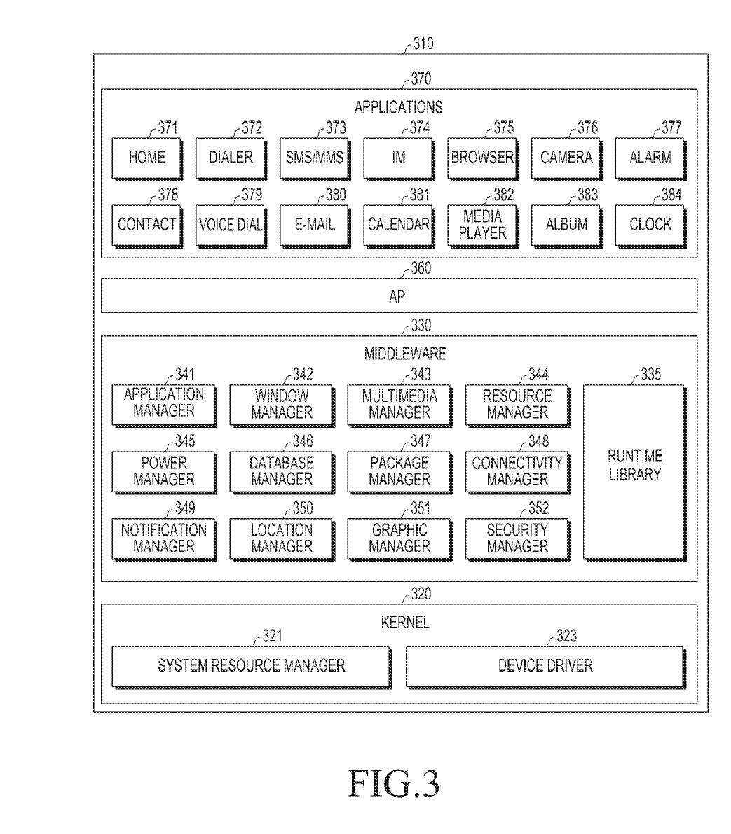

FIG. 3 is a block diagram of a program module according to embodiments of the present disclosure.

In one embodiment, a program module 310 includes an OS for controlling the resources related to the electronic device, and/or a variety of applications 370 that execute on the operating system. The OS may be, Android™, iOS™, Windows™, Symbian™, Tizen™, Bada™ or the like.

The program module 310 includes a kernel 320, a middleware 330, an application programming interface (API) 360, and/or applications 370. At least a part of the program module 310 may be preloaded on the electronic device, or downloaded from the external electronic device, such as one of the electronic devices 102 and 104 or the server 106.

The kernel 320 includes a system resource manager 321 and/or a device driver 323. The system resource manager 321 controls, allocates and recovers the system resources, and includes a process manager, a memory manager, a file system manager or the like. The device driver 323 includes a display driver, a camera driver, a Bluetooth driver, a shared memory driver, a USB driver, a keypad driver, a WiFi driver, an audio driver, or an inter-process communication (IPC) driver.

The middleware 330 may provide a function that is required in common by the applications 370, or may provide various functions to the application 370 through the API 360 so that the applications 370 may efficiently use the limited system resources within the electronic device. In one embodiment, the middleware 330 includes at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 includes a library module that a compiler uses to add a new function through a programming language while the application 370 is run. The runtime library 335 performs I/O management, memory management, and arithmetic functions.

The application manager 341 may manage the life cycle of at least one of the applications 370. The window manager 342 manages the graphic user interface (GUI) resources that are used on the screen. The multimedia manager 343 determines the format required for playback of various media files, and encodes or decodes the media files using a codec for the format. The resource manager 344 manages resources such as a source code, a memory or a storage space for at least one of the application(s) 370.

The power manager 345, manages the battery or power by operating with the basic input/output system (BIOS), and provides power information required for an operation of the electronic device. The database manager 346 may create, search or update the database that is to be used by at least one of the application(s) 370. The package manager 347 manages installation or update of applications that are distributed in the form of a package file.

The connectivity manager 348 manages wireless connection such as WiFi or Bluetooth. The notification manager 349 may indicate or notify events such as message arrival, appointments and proximity in a manner that doesn't interfere with the user. The location manager 350 manages the location information of the electronic device. The graphic manager 351 manages the graphic effect to be provided to the user, or the user interface related thereto. The security manager 352 may provide various security functions required for the system security or user authentication. In one embodiment, if the electronic device includes a phone function, the middleware 330 may further include a telephony manager for managing the voice or video call function of the electronic device.

The middleware 330 includes a middleware module that forms a combination of various functions of the above-described components, and provides a module specialized for each type of the operating system in order to provide a differentiated function. The middleware 330 may dynamically remove some of the existing components, or add new components.

The API 360 is a set of API programming functions, and may be provided in a different configuration depending on the operating system. For example, for Android™ or iOS™, the API 360 may provide one API set per platform, and for Tizen™, the API 360 may provide two or more API sets per platform.

The application 370 includes one or more applications capable of performing such functions as home 371, dialer 372, short message service/multimedia messaging service (SMS/MMS) 373, instant message (IM) 374, browser 375, camera 376, alarm 377, contact 378, voice dial 379, email 380, calendar 381, media player 382, album 383, clock 384, healthcare, such as a function for measuring the quantity of exercise, the blood glucose or the like), or environmental information provision functions, such as a function for providing information about the atmospheric pressure, the humidity, or the temperature.

In one embodiment, the application 370 includes an information exchange application for supporting information exchange between the electronic device, such as 101 and external electronic devices, such as 102 and 104. The information exchange application includes a notification relay application for delivering specific information to the external electronic devices, or a device management application for managing the external electronic devices.

For example, the notification relay application includes a function of delivering notification information generated in other applications, such as SMS/MMS, email, healthcare, or an environmental information application of the electronic device, to the external electronic devices 102 and 104. The notification relay application may receive notification information from an external electronic device, and provide the received notification information to the user.

The device management application may manage at least one function, such as adjusting the turn-on/off of the external electronic device itself or some components thereof, or the resolution of the display of the external electronic device 102 or 104 communicating with the electronic device, and installs, deletes or updates an application operating in the external electronic device or a service, such as a call service or a messaging service provided in the external electronic device.

In one embodiment, the applications 370 include a healthcare application for a mobile medical device that is specified depending on the properties (indicating that the type of the electronic device is the mobile medical device) of the external electronic device 102 or 104. In one embodiment, the applications 370 include an application received or downloaded from the external electronic device, and includes a preloaded application or a third party application that can be downloaded from the server. The names of the components of the illustrated program module 310 may vary depending on the type of the operating system.

According to embodiments of the present disclosure, at least a part of the program module 310 may be implemented by software, firmware, hardware or a combination thereof. At least a part of the program module 310 may be executed by a processor. At least a part of the program module 310 includes a module, a program, a routine, an instruction set or a process, for performing one or more functions.

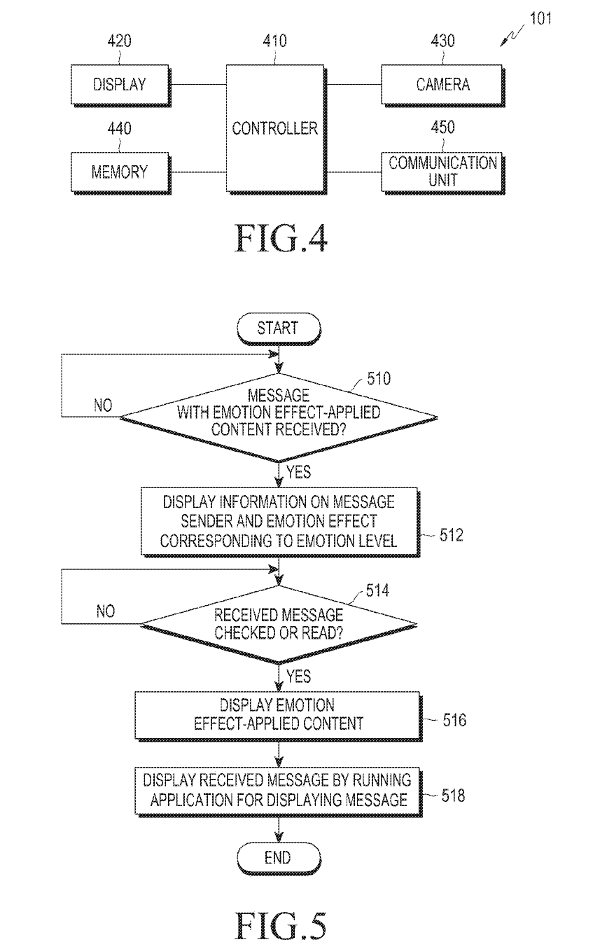

FIG. 4 is a block diagram illustrating an electronic device that displays an emotion effect on the displayed content according to embodiments of the present disclosure.

In one embodiment, an electronic device 101 includes a display 420, a camera 430, a memory 440, a communication unit 450 and a controller 410.

The display 420 performs at least one function or operation performed in the display 160 of FIG. 1. The display 420 displays a variety of content, such as texts, images, videos, icons, or symbols. The display 420 may apply an emotion effect, such as emoticons, icons, or heart signs representing the user's emotions, onto a variety of displayed content. The display 420 includes a touch screen, and may receive a touch input, a gesture input, a proximity input or a hovering input made by an electronic pen or a part of the user's body. The display 420 displays an emotion effect generated by the controller 410, on the displayed content. The emotion effect includes emoticons, icons, or characters that can represent emotions of the user watching the displayed content.

The emotion effect according to an embodiment of the present disclosure is to represent emotions of the user who has watched the content, and includes a variety of information that others can estimate emotions of the user who has watched the content, based on the emotion effect. The display 420 displays a message application for exchanging messages for exchanging texts or content with other electronic devices, and displays an emoticon replacing the content received from the other electronic devices, on the message application. The display 420 replaces the displayed emoticon with the content in response to selection of the emoticon by a user of an electronic device that has received the content. Upon receiving a message including emotion effect-applied content from another electronic device, the display 420 displays information about the sender who has sent the message, and an emotion level of the emotion effect. The sender information includes at least one of the sender's name, phone number and photo. The emotion level is determined based on at least one of recognition of a face of a user viewing the displayed content and a touch on the displayed content.

The camera 430 performs at least one function or operation performed in the camera module 291 of FIG. 2. The camera 430 is capable of capturing still images and videos, and includes one or more image sensors, such as front and rear image sensors, a lens, an image signal processor (ISP), or a flash, such as an LED or xenon lamp. The camera 430 may be automatically activated when content is displayed on the display 420, or may be activated selectively, such as by the user. When content is displayed on the display 420, the camera 430 may track the user's eyes to determine which portion or point of the displayed content the user is presently watching.

The memory 440 performs at least one function or operation performed in the memory 130 of FIG. 1. The memory 440 may store a command or data related to at least one other component of the electronic device 101. In one embodiment, the memory 130 may store software and/or a program 140. The memory 440 may store an application or program capable of tracking the user's eyes, an application or program capable of adding the user's emotion effect onto the displayed content, various icons, emoticons and characters capable of representing the user's emotion effects, and a variety of content such as photos and videos, to which the emotion effects can be applied. The memory 440 may accumulate and store the number of transmissions by the senders who have sent the message including the content to which the emotion effects are applied, and may group and store the senders depending on the accumulated number of transmissions. The grouping includes grouping the senders in the order of the greater number of transmissions.

The communication unit 450 performs at least one function or operation performed in the communication interface 170 of FIG. 1. The communication unit 450 may, establish communication between the electronic device 101 and external devices, such as the first external electronic device 102, the second external electronic device 104, or the server 106). For example, the communication unit 450 transmits and receives content to/from the external device, such as the second external electronic device 104 or the server 106, by being connected to the network 162 through wireless communication or wired communication. The communication unit 450 transmits and receives the content including the emotion effect. The communication unit 450 may form or connect a sympathetic channel to another electronic device that transmits and receives the content including the emotion effect. The communication unit 450 transmits and receives an emotion level, an emotion effect corresponding to the emotion level and information about the coordinates on which the emotion effect is displayed, to/from another electronic device through the sympathetic channel in real time. The communication unit 450 transmits and receives an emotion level, an emotion effect corresponding to the emotion level and information about the coordinates on which the emotion effect is displayed, to/from another electronic device in real time. The emotion level is determined based on at least one of recognition of a face of a user viewing the displayed content and a touch on the displayed content.

The controller 410 performs at least one function or operation performed in the processor 120 of FIG. 1. The controller 410 includes one or more of a central processing unit (CPU), an application processor (AP), or a communication processor (CP). The controller 410 may, execute a control and/or communication-related operation or data processing for at least one other component of the electronic device 101.

The controller 410 may execute a message application, if an input to send a message is detected from the user. If content to be transmitted is selected, the controller 410 transmits the selected content by using (or through) the executed message application, and displays an emoticon replacing the transmitted content on the executed message application. The controller 410 may execute the message application, and display a message exchanged between a sender and a recipient by using the executed message application. The controller 410 transmits and receives the content by using the message application, or transmits and receives the emotion effect-applied content. When the emotion effect-applied content is transmitted, the controller 410 displays an emoticon corresponding to the content without immediately displaying the emotion effect-applied content on the message application.

The controller 410 displays the emotion effect-applied content if a predetermined time has elapsed after the emoticon was displayed. Otherwise, the controller 410 displays the emotion effect-applied content upon receiving a signal indicating the touch of the emoticon from an electronic device of the recipient. The signal may be transmitted and received through the sympathetic channel. The controller 410 displays an emotion effect corresponding to the user's emotion level on the displayed content, and the emotion effect includes various emoticons, such as heart signs and lightning signs, icons and characters. The emotion effect may be displayed differently depending on the emotion level. The emotion level is determined based on at least one of recognition of a face of a user viewing the displayed content and a touch on the displayed content.

For example, if the probability that the user is laughing is at least 50%, an emotion effect corresponding to Level 1 may be displayed. If the probability that the user is laughing is at least 70%, an emotion effect corresponding to Level 2 may be displayed. If the probability that the user is laughing is at least 90%, an emotion effect corresponding to Level 3 may be displayed. The probability for each level may be adjusted. As a result of recognizing the user's facial expression, Level 1 corresponds to, when the probability that the user is laughing is at least 50% (or 50%-69%) or the extent of the user's laugh is low, such as smiling, and in this case, a relatively large heart sign may be displayed. Level 2 corresponds to, when the probability that the user is laughing is at least 70% (or 70%˜89%) or the extent of the user's laugh is normal, such as smiling and showing teeth, and in this case, a relatively large heart sign and a small heart sign may be displayed. Level 3 corresponds to, when the probability that the user is laughing is at least 90% or the extent of the user's laugh is high, such as applause mixed with laughter, or laughter detected, and in this case, a relatively large heart sign and a plurality of small heart signs may be displayed.

The controller 410 may, connect a sympathetic channel to the electronic device that has received the content, and if an input is detected while the content is displayed, the controller 410 determines an emotion level based on the detected input and applies an emotion effect corresponding to the determined emotion level onto the displayed content. The controller 410 determines whether an emotion effect has been applied to the content to be transmitted. For example, if an emotion effect has been applied to the content, the controller 410 connects a sympathetic channel to the electronic device that will receive the content. Otherwise, if the content, to which an emotion effect is applied while a message application is executed, is transmitted to at least one electronic device corresponding to the running message application, the controller 410 connects a sympathetic channel to the at least one electronic device.

The sympathetic channel transmits the user's emotion effect in real time between the electronic device transmitting the emotion effect-applied content and at least one electronic device receiving the content. The controller 410 transmits the emotion level and information about the coordinates on which the emotion effect is displayed, to at least one electronic device that has received the content through the sympathetic channel. If the emotion level and information about the coordinates on which the emotion effect is displayed are received from the electronic device that has received the content, the controller 410 displays the emotion effect corresponding to the emotion level at the point corresponding to the received coordinate information on the content. If an input is detected while the content is displayed, the controller 410 determines the user's emotion level based on the detected input.

The input includes at least one of recognition of the face of the user viewing the displayed content and a touch on the displayed content. The controller 410 determines the user's emotion level based on an expression degree of the recognized user's face, or determines the user's emotion level based on at least one of duration of the touch and the number of touches. When the detected input is the recognition of the face of the user viewing the displayed content, as the expression degree of the user's face increases, the emotion level may be determined to be high. When the detected input is the touch on the displayed content, the emotion level may be determined to be high, if the duration of the touch or the number of touches is greater than or equal to a threshold.

The controller 410 may detect an input on the content displayed on the display 420. If the content is displayed on the display 420, the controller 410 may activate the camera 430 and recognize the user's face by using the activated camera 430. The input includes at least one of recognition of the face of the user viewing the displayed content and a touch or hovering on the displayed content. The controller 410 may activate the camera 430 and detect a change in the position of the user's eyes, nose, gaze or mouth on the displayed content, to determine whether the user is presently smiling, crying, sad, or happy. As for these criteria, a threshold for each expression may be stored in the memory 440, and the controller 410 determines the user's emotion based on the threshold and the currently recognized user's face. The controller 410 determines the user's emotion based on the expression degree of the recognized user's face.

The controller 410 may detect an input by at least one of a touch and hovering on the display 420 on which the content is displayed, and determine a point, such as coordinates at which the input is detected. The controller 410 determines the user's emotion based on at least one of the duration and the number of the touches or hovering. The controller 410 may the number of the touches or hovering for a predetermined time, thereby to determine that as the number of times the touches or hovering have been made is larger, the user's emotion level increases. For example, if the content displayed on the display 420 is a baby photo, the user may make a heartwarming expression, watching the displayed content, and touch the displayed content. In this case, the controller 410 may recognize the user's face and determine that the user is feeling joy. Depending on the expression degree of the user's face or the number of touches, the controller 410 determines that the user's emotion level is high.

The controller 410 may display an emotion effect at the touched point, if the detected input is at least one of the touch and hovering. If the detected input is face recognition by the camera 430, the controller 410 may analyze the user's eyes or gaze and display an emotion effect at the position of the analyzed gaze. The controller 410 may store, in the memory 440, an identifier of the content displayed on the display 420, a name of the content, a user's emotion level, and information about the coordinates on which an emotion effect is displayed.

Upon receiving a message including emotion effect-applied content, the controller 410 may, display on the display 420 the information about the sender who has sent the message and an emotion level of the emotion effect, and display the emotion effect-applied content on the display 420 in response to the user's check or read of the received message. Upon receiving a message including emotion effect-applied content, the controller 410 displays the face of the sender who has sent the message, in a partial area of the display 420.

Upon receiving a message including emotion effect-applied content, the controller 410 displays an emotion effect corresponding to the emotion level in a partial area of the display 420. The emotion effect includes a flash sign. For example, as the emotion effect or level increases, the brighter flash may be displayed. The user information or sender information and the emotion effect may be displayed on an initial screen of the electronic device 101. The controller 410 displays the content included in the message on the display 420 ahead of the contents of the message in response to the user's check of the received message. Thereafter, if a predetermined time has elapsed or if an input to check or read the contents of the message is detected, the controller 410 may execute the corresponding application to display the contents of the message, and display the message contents by using the executed application.

The controller 410 may, accumulate the number of transmissions by the senders who have sent the message including the emotion effect-applied content, group the senders depending on the accumulated number of transmissions, and store the resulting information in the memory 440. The controller 410 may accumulate the emotion effect for each sender who has sent the message. Otherwise, the controller 410 may classify the senders depending on the types of the emotion effects. The controller 410 may group the senders in the order of the greater number of transmissions that the senders have sent the messages including the emotion effect-applied content, and display the grouping results on the display 420.

The controller 410 may execute an application for displaying a received message to display the received message. The application may be execute after a lapse of a predetermined time after the content was displayed, or by the user's command to display the received message. The emotion effect may correspond to the sender's emotion level for the content.

FIG. 5 illustrates a process of receiving content according to embodiments of the present disclosure.

If a message including emotion effect-applied content is received in step 510, the electronic device 101 displays information about the sender who has sent the message and the emotion effect corresponding to the emotion level, in step 512. If the message is not received, step 510 is repeated. Upon receiving the message, the electronic device 101 determines whether content is included in the received message, or whether an emotion effect is included in the received message. Otherwise, upon receiving the message, the electronic device 101 determines whether an emotion effect is applied to the content included in the received message.

For example, if an emotion effect is applied to the content included in the received message, the electronic device 101 displays, on the display 420, information about the sender who has sent the message, and the emotion effect. Otherwise, if an emotion effect is applied to the content included in the received message, the electronic device 101 displays the photo and name of the sender who has sent the message, on the current screen of the display 420. The user information or sender information includes a variety of information based on which the sender who has sent the message may be identified, such as face photos, emoticons or icons. The emotion effect includes a variety of information representing emotions, such as icons, flash signs, emoticons and characters corresponding to the sender's emotion level for the content included in the message. The electronic device 101 displays the user information on the top of the display 420, and display the emotion effect on the icon indicating receipt of the message.

If the received message is checked or read in step 514, the electronic device 101 displays the emotion effect-applied content in step 516. If the displayed user information is selected or the displayed emotion effect is selected in step 514, the electronic device 101 displays the emotion effect-applied content on the screen on which the message is received in step 516. The content may be played or displayed in the input order of the emotion effect applied by the sender. Otherwise, if an emotion effect including the sound is applied to the content, the electronic device 101 may, display or output the emotion effect together with the playback of the sound. If the received message is not checked or read in step 514, the process repeats step 514.

The electronic device 101 displays the received message by executing the application for displaying a message in step 518. If a predetermined time has elapsed after the emotion effect-applied content was displayed, the electronic device 101 executes the application capable of displaying a message, and display the received message by using the executing application. Otherwise, if an input by touch or hovering is detected from the user while the emotion effect-applied content is displayed, the electronic device 101 executes the application capable of displaying a message, and display the received message by using the executed application. The electronic device 101 transmits a signal to an electronic device that has sent the message, in response to the display of the received message. The signal may be transmitted through a sympathetic channel connected between the electronic device 101 and the electronic device that has sent the message. If an input is detected on the displayed content, the electronic device 101 determines an emotion level of the user who has made the input, based on the detected input, and applies an emotion effect corresponding to the determined emotion level onto the displayed content. The detected input includes at least one of recognition of the face of the user viewing the displayed content, and a touch and/or hovering on the displayed content.

The electronic device 101 may activate the camera for recognizing the user's face in response to the display of the content. The electronic device 101 may determine the user's emotion by recognizing the user's face expression by using the camera 430. Otherwise, the electronic device 101 may determine the user's emotion through at least one of the duration and the number of the inputs by the touch or hovering on the displayed content. As the expression degree of the user's face increases, the electronic device 101 determines the emotion level to be higher. If the duration of the touch is greater than or equal to a threshold, or if the number of touches is greater than or equal to a threshold, the electronic device 101 determines the emotion level to be high. If the input detected on the displayed content is a touch, the electronic device 101 displays the emotion effect at the touched point. The electronic device 101 transmits and receives an emotion effect and information about the coordinates of the display 420 on which the emotion effect is displayed, to/from the electronic device that has transmitted the content, through the sympathetic channel in real time in response to the input.

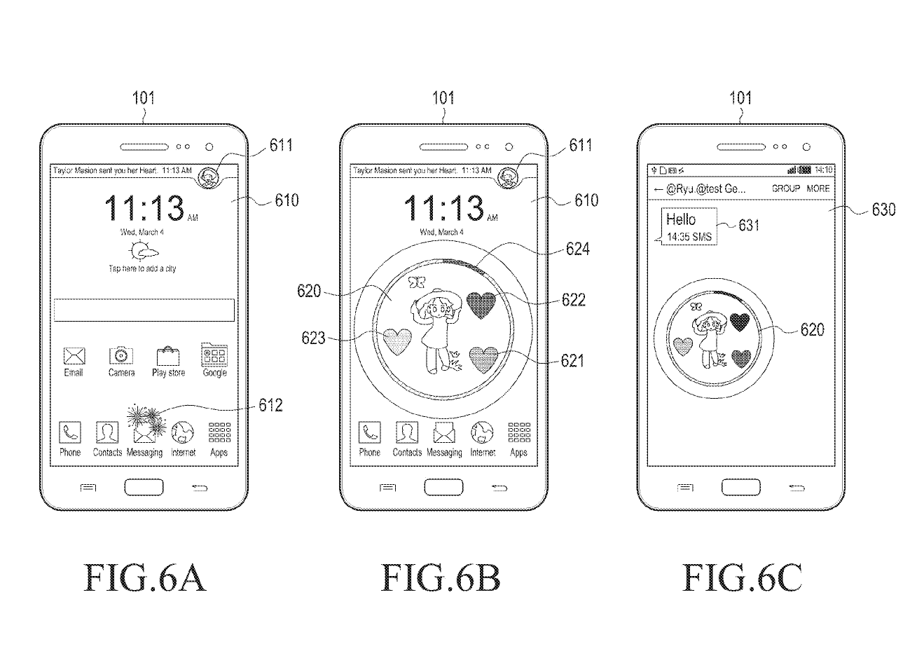

FIG. 6A illustrates the reception of a message including content according to embodiments of the present disclosure. FIG. 6B illustrates the check or read of a message including content according to embodiments of the present disclosure. FIG. 6C illustrates the display of a message including content according to embodiments of the present disclosure.

Referring to FIG. 6A, the electronic device 101 displays a standby screen 610 on the display 420. If a message including emotion effect-applied content is received while the standby screen 610 is displayed, the electronic device 101 displays user information 611 about the sender who has transmitted the message, in a partial area of the standby screen 610, and display an emotion level or effect 612 of the content included in the message, in a partial area of the standby screen 610. If at least one of the user information 611 and the emotion level 612 is selected while the standby screen 610 is displayed as shown in FIG. 6A, the electronic device 101 displays the content included in the message as shown in FIG. 6B.

Referring to FIG. 6B, if at least one of the user information 611 and the emotion level 612 is selected while the standby screen 610 is displayed as shown in FIG. 6A, the electronic device 101 displays the content 620 included in the message. The displayed content 620 includes at least one or more emotion effects 621, 622, 623 and 624 which may be played or displayed in chronological order. If at least one of the user information 611 and the emotion level 612 is selected, the electronic device 101 displays or plays the at least one or more emotion effects 621, 622, 623 and 624 in the order in which the emotion effects were entered by the sender who has transmitted the message, such as on the standby screen 610, or on an application capable of playing the message. After a predetermined time has elapsed or the application is executed by the user's input while the content was displayed, the application displays the contents of the message as shown in FIG. 6C.

Referring to FIG. 6C, if a predetermined time has elapsed or a user's input is detected while the at least one or more emotion effects 621, 622, 623 and 624 were displayed, as shown in FIG. 6B, the electronic device 101 displays the contents of the message. The message includes the content 620 to which at least one emotion effect is applied, and a text 631. If a predetermined time has elapsed or a user's input is detected while the at least one or more emotion effects 621, 622, 623 and 624 were displayed, the electronic device 101 may execute an application 630 capable of executing or displaying the message. The electronic device 101 displays the received message on the executed application 630.

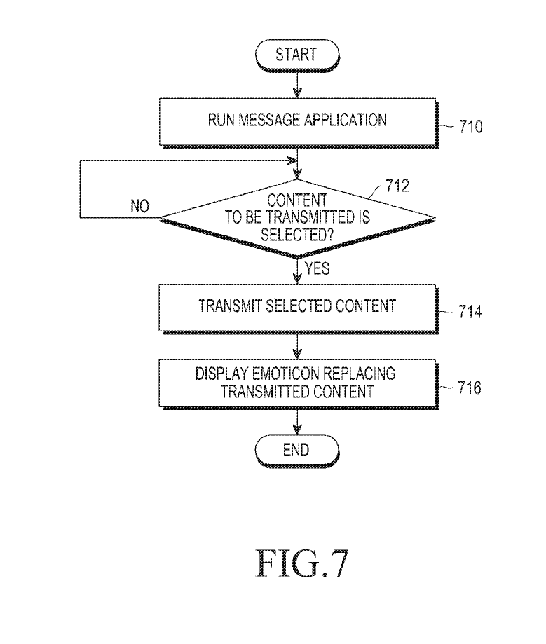

FIG. 7 illustrates a process of transmitting content according to embodiments of the present disclosure.

The electronic device 101 executes a message application for transmitting and receiving a message in step 710. The electronic device 101 transmits and receives messages to/from at least one user by executing various interactive applications, such as a text messaging application, a KakaoTalk™ application. The electronic device 101 transmits and receives a variety of content such as photos, videos and emoticons, by using the executed application. Otherwise, the electronic device 101 transmits and receives at least one content item to which the user's emotion effect is applied, and its associated text, by using the application.

If the content to be transmitted is selected in step 712, the electronic device 101 transmits the selected content in step 714. Otherwise, step 712 is repeated.

While transmitting and receiving the texts to/from any recipient, the electronic device 101 transmits the content selected by the user. The content may be content to which the user's emotion effect is applied. If the content to be transmitted is selected while the message application is executed, the electronic device 101 transmits the selected content by using the executed message application. The electronic device 101 connects a sympathetic channel to other electronic device that will receive the content. If an input on the content is detected while the sympathetic channel is connected to the electronic device that has received the content, the electronic device 101 determines an emotion level based on the detected input, and applies an emotion effect corresponding to the determined emotion level onto the displayed content. The electronic device 101 transmits the emotion effect and information about the coordinates on which the emotion effect is displayed, to the other electronic device through the connected sympathetic channel. If an input by the user of the other electronic device is generated while the content is displayed on the other electronic device, the electronic device receives, from the other electronic device, an emotion effect corresponding to the input and information about the coordinates on the display, to which the emotion effect is applied.

The electronic device 101 displays an emoticon replacing the transmitted content in step 716. The electronic device 101 displays an emoticon capable of replacing transmitted content on the application in response to the transmission of the content. For example, the emoticon instead of the content may be displayed on the application of the electronic device 101 that has transmitted the content, and the application of the other electronic device that has received the content. Upon receiving a signal indicating the touch on the emoticon from the other electronic device, the electronic device 101 displays the emotion effect-applied content. The signal may be transmitted and received through a sympathetic channel. The sympathetic channel transmits the user's emotion effect between the electronic device 101 and the other electronic device in real time. For this sympathetic channel, a channel that is separately created or connected in advance may be used.

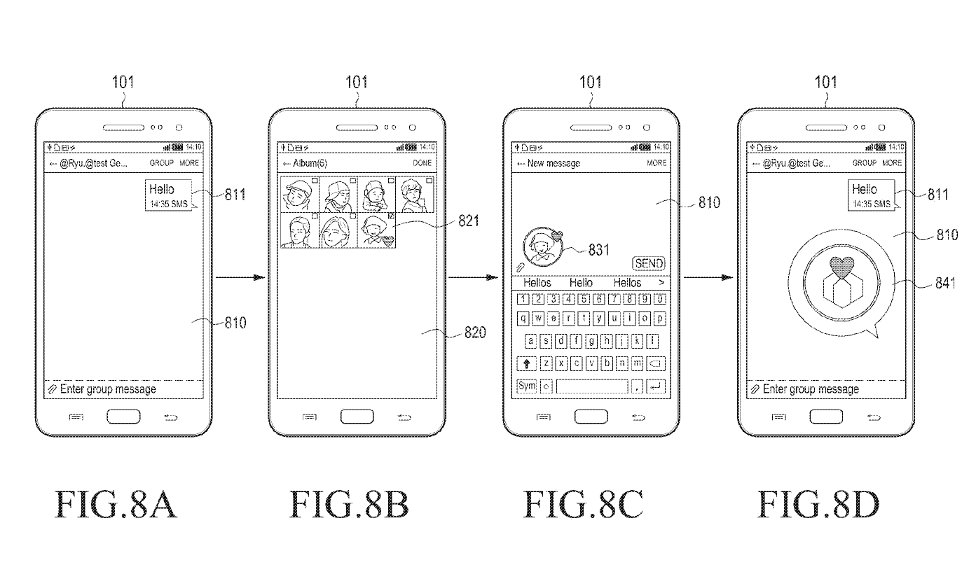

FIG. 8A illustrates the transmission of a message by using an application according to embodiments of the present disclosure. FIG. 8B illustrates the selection of emotion effect-applied content according to embodiments of the present disclosure. FIG. 8C illustrates the transmission of emotion effect-applied content according to embodiments of the present disclosure. FIG. 8D illustrates the display of an emoticon replacing the content according to embodiments of the present disclosure.

Referring to FIG. 8A, the electronic device 101 transmits a message 811 to another electronic device by executing a message application 810. The electronic device 101 receives a message from the other electronic device by using the executed message application 810. The electronic device 101 transmits content to the other electronic device by using the executed message application 810.

Referring to FIG. 8B, the electronic device 101 selects content 821 to be transmitted, and transmits the selected content 821 to the other electronic device by using the executed message application 810. The electronic device 101 may execute a corresponding application 820 for selecting the content 821 to be transmitted. The electronic device 101 displays a plurality of thumbnails of content stored in the memory 440. The electronic device 101 displays the emotion effect-applied thumbnails together with the emotion effects. The user selects at least one thumbnail from among the plurality of thumbnails, and the electronic device 101 transmits content corresponding to the selected at least one thumbnail to the other electronic device.

Referring to FIG. 8C, the electronic device 101 writes or creates a message, such as text, to be transmitted together with the selected content, and transmits the message to the other electronic device. The content 821 selected in FIG. 8B may be displayed in the manner of content 831 in FIG. 8C, allowing the user to determine which content is to be transmitted. As such, the electronic device 101 transmits the selected content by using the message application 810.

Referring to FIG. 8D, the electronic device 101 transmits the message 811 and the selected content by using the message application 810. The electronic device 101 displays an emoticon 841 capable of replacing content, instead of the content selected in FIG. 8B. The electronic device 101 displays the emoticon 841 capable of replacing content, instead of displaying the selected content, for a predetermined time. If a predetermined time has elapsed or the user of the electronic device that has received the content has touched an emoticon corresponding to the content while the emoticon 841 was displayed, the electronic device 101 replaces the emoticon 841 with the corresponding content. Upon receiving a signal indicating the touch of the emoticon from the electronic device of the recipient, the electronic device 101 displays the emotion effect-applied content. The signal may be transmitted and received though a sympathetic channel.

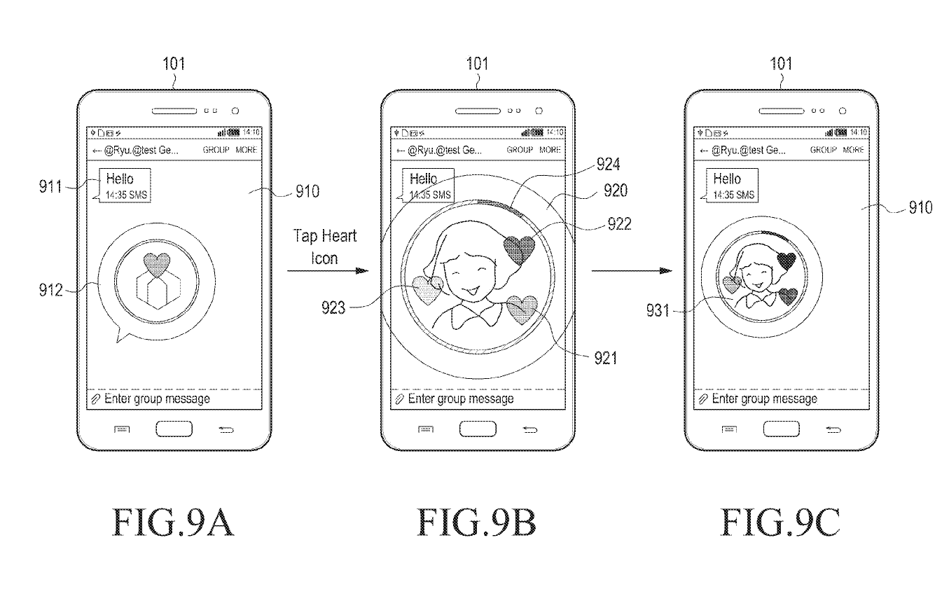

FIG. 9A illustrates the reception of an emoticon replacing the content according to embodiments of the present disclosure. FIG. 9B illustrates the playback of an emotion effect by the selection of the received content according to embodiments of the present disclosure. FIG. 9C illustrates the display of the emotion effect on an application after completion of the playback of the emotion effect according to embodiments of the present disclosure.

Referring to FIG. 9A, the electronic device 101 receives a message 911 and emotion effect-applied content by using an application 910. The electronic device 101 displays an emoticon 912 capable of replacing content, instead of displaying the received content. The electronic device 101 displays the emoticon 912 for a predetermined time. If a predetermined time has elapsed or the user has touched the emoticon 912 while the emoticon 912 was displayed, the electronic device 101 replaces the emoticon 912 with the corresponding content. If the emoticon 912 is touched or tapped, the electronic device 101 transmits a signal indicating the touch of the emoticon to the electronic device that has transmitted the content. The signal may be transmitted and received through the sympathetic channel.

Referring to FIG. 9B, upon detecting an input by a touch or hovering on the displayed emoticon 912, the electronic device 101 may play or display at least one or more emotion effects 921, 922, 923 and 924 applied to the content 920 in their input order. Otherwise, at least one or more emotion effects may be played or displayed in chronological order. The electronic device 101 displays or plays the at least one or more emotion effects 921, 922, 923 and 924 in the order in which the emotion effects were entered by the sender who has transmitted the message. If an emotion effect including the sound is applied to the content 920, the electronic device 101 displays or outputs the emotion effect together with the playback of the sound. After the at least one or more emotion effects 921, 922, 923 and 924 of the content 920 are played, content 931, the playback of emotion effects of which is completed, may be displayed on the application 910 as shown in FIG. 9C.

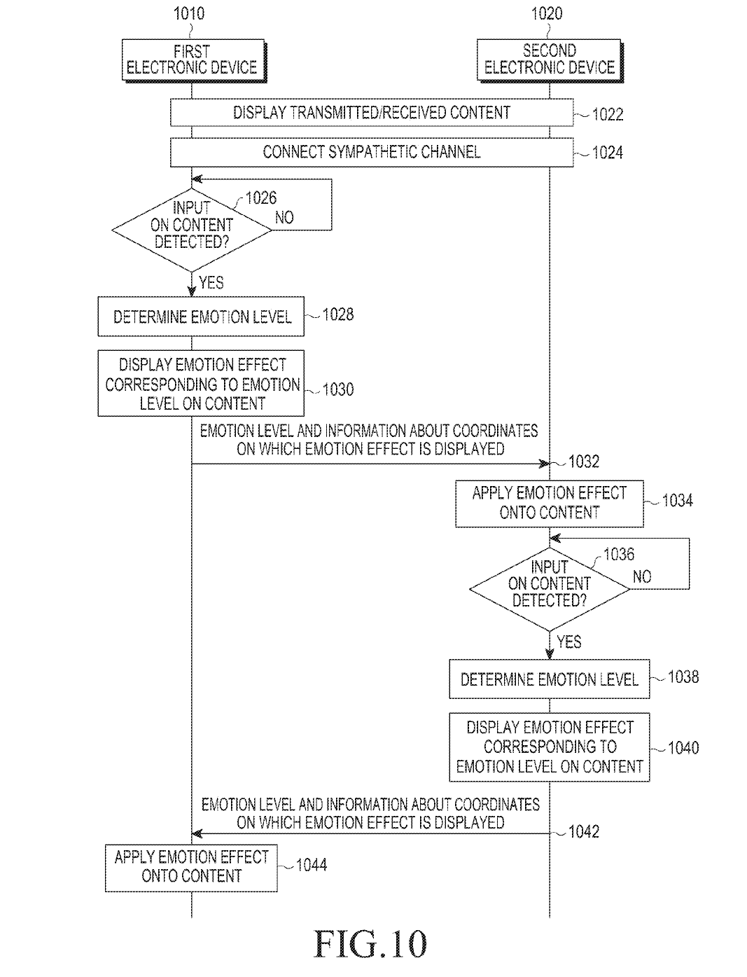

FIG. 10 illustrates a process of transmitting and receiving content according to embodiments of the present disclosure.

A first electronic device 1010 and a second electronic device 1020 display the content that is transmitted and received, in step 1022. At least one of the first electronic device 1010 and the second electronic device 1020 may execute a message application to transmit and receive a message, such as when detecting an input to transmit a message from the user, and transmit and receive content by using the executed message application. At least one of the first electronic device 1010 and the second electronic device 1020 may execute a variety of interactive applications, such as a text messaging application, a KaKaoTalk™ application, etc.), to transmit and receive messages to/from at least one or more users. At least one of the first electronic device 1010 and the second electronic device 1020 transmits and receives a variety of content such as photos, videos and emoticons by using the executed application. Otherwise, at least one of the first electronic device 1010 and the second electronic device 1020 transmits and receives at least one content item to which the user's emotion effect is applied, and its associated text, by using the application.

The first electronic device 1010 and the second electronic device 1020 connect a sympathetic channel to transmit and receive or to play the emotion effect applied to the content, in step 1024. At least one of the first electronic device 1010 and the second electronic device 1020 may form or connect the sympathetic channel to other electronic device that transmits and receives content including an emotion effect. At least one of the first electronic device 1010 and the second electronic device 1020 transmits and receives an emotion level, an emotion effect corresponding to the emotion level and information about the coordinates on which the emotion effect is displayed, to/from the other electronic device through the sympathetic channel in real time. At least one of the first electronic device 1010 and the second electronic device 1020 transmits and receives an emotion level, an emotion effect corresponding to the emotion level and information about the coordinates on which the emotion effect is displayed, to/from the other electronic device in real time.

If an input on the content is detected in step 1026 while the content is displayed, the first electronic device 1010 determines an emotion level in step 1028. Otherwise, step 1026 is repeated.

The first electronic device 1010 displays the content such as photos, pictures and videos. If the content is displayed, the first electronic device 1010 may recognize the user's face by activating the camera. Otherwise, if a command to activate the camera is received from the user while the content is displayed, the first electronic device 1010 may recognize the user's face by activating the camera. The first electronic device 1010 determines the state of the user's emotion based on the user's expression, such as eyes, nose, and mouth recognized by using the activated camera, or on the change in the expression. The first electronic device 1010 determines the current state of the user's expression through the standard face threshold that corresponds to the emotion and is stored in the memory. The first electronic device 1010 determines the current user's emotion level based on the recognized user's face. The input includes at least one of recognition of the face of the user viewing the displayed content, and a touch or hovering on the displayed content. The first electronic device 1010 may detect a hovering input on the displayed content, and determine the user's emotion based on the input by hovering. The first electronic device 1010 determines the user's emotion level based on the degree of the change in the user's expression, or the number of touches. For example, the first electronic device 1010 determines whether the user's expression recognized by using the camera is a smiling expression, a laughing expression or an angry expression. The first electronic device 1010 determines the degree of these expressions. The first electronic device 1010 determines the user's emotion based on the expression degree of the user's face. The first electronic device 1010 determines the user's emotion based on at least one of the duration and the number of the inputs by the touch or hovering. As the expression degree of the recognized user's face increases, the first electronic device 1010 determines that the emotion level increases. If the duration of the touch is greater than or equal to a threshold or the number of touches is greater than or equal to a threshold, the first electronic device 1010 determines that the emotion level is high.

The first electronic device 1010 displays an emotion effect corresponding to the emotion level on the content in step 1030. The first electronic device 1010 displays an emotion effect corresponding to the user's emotion level on the displayed content, and the emotion effect includes various emoticons, such as heart signs and lightning signs, icons and characters. If the input is at least one of the touch and hovering, the first electronic device 1010 displays the emotion effect at the touched point. If the input is recognition of the user's face, the first electronic device 1010 displays the emotion effect at the point where the user's gaze is positioned. The emotion effect may be moved on the display by the user's command, such as touch-and-drag, and gaze.

The first electronic device 1010 may resize the emotion effect depending on the user's emotion level, and display the resized emotion effect on the content. The first electronic device 1010 may adjust the size, color or shape depending on the user's emotion level and display the results on the content. The first electronic device 1010 may store the emotion effect-applied content. The first electronic device 1010 may store an identifier of the displayed content, a name of the content, a user's emotion level, and information on the coordinates of the display, on which the emotion effect is displayed. If a call to the stored content occurs, the first electronic device 1010 displays the emotion effect together with the content. In this case, the displayed emotion effect may be displayed in response to the emotion level.

The first electronic device 1010 transmits an emotion level and information about the coordinates of the display, on which the emotion effect is displayed, to the second electronic device 1020 through the connected sympathetic channel in step 1032. The first electronic device 1010 transmits an emotion level corresponding to the input detected in step 1026 and information about the coordinates on which an emotion effect corresponding to the emotion level is displayed, to the second electronic device 1020 through the sympathetic channel. Although the second electronic device 1020 is shown as only one electronic device, this is the only example, and a plurality of electronic devices may be provided.

The second electronic device 1020 receives an emotion level and information about the coordinates on which an emotion effect corresponding to the emotion level is displayed, from the first electronic device 1010 in step 1032. If an emotion level and information about the coordinates on which an emotion effect is displayed, are received from the first electronic device 1010, the second electronic device 1020 displays an emotion effect corresponding to the emotion level at a point corresponding to the received coordinate information on the displayed content, in step 1034. For example, upon receiving an emotion effect-applied sound, the second electronic device 1020 may play the received sound together with playback of the emotion effect. The second electronic device 1020 receives, in real time, an emotion level and information about the coordinates on which an emotion effect is displayed, in response to the input detected in step 1036.

If an input on the content is detected in step 1036 while the content is displayed, the second electronic device 1020 determines an emotion level in step 1038. If an input on the content is detected while the content is displayed, the second electronic device 1020 determines an emotion level, as in the first electronic device 1010. If the content is displayed, the second electronic device 1020 may activate the camera and recognize the user's face. Otherwise, if a command to activate the camera is received from the user while the content is displayed, the second electronic device 1020 may activate the camera and recognize the user's face. The second electronic device 1020 determines the state of the user's emotion based on the user's expression, such as eyes, nose, and mouth, recognized by using the activated camera, or on the change in the expression. The second electronic device 1020 determines the current state of the user's expression based on the standard face threshold that corresponds to the emotion and is stored in the memory. The second electronic device 1020 determines the current user's emotion level based on the recognized user's face.

The second electronic device 1020 may detect a hovering input on the displayed content, and determine the user's emotion based on the input by hovering. The second electronic device 1020 determines the user's emotion level based on the degree of the change in the user's expression, or the number of touches. The second electronic device 1020 determines the user's emotion based on at least one of the duration and the number of the touches or hovering. As the expression degree of the recognized user's face increases, the second electronic device 1020 determines that the emotion level increases. If the duration of the touch is greater than or equal to a threshold or the number of touches is greater than or equal to a threshold, the second electronic device 1020 determines that the emotion level is high.

The second electronic device 1020 displays an emotion effect corresponding to the emotion level on the content in step 1040. The second electronic device 1020 displays an emotion effect corresponding to the user's emotion level on the displayed content, and the emotion effect includes various emoticons, such as heart signs and lightning signs, icons and characters. If the input is at least one of the touch and hovering, the second electronic device 1020 displays the emotion effect at the touched point. If the input is recognition of the user's face, the second electronic device 1020 displays the emotion effect at the point where the user's gaze is positioned.

The second electronic device 1020 transmits an emotion level and information about the coordinates on which an emotion effect is displayed, to the first electronic device 1010 through the connected sympathetic channel in step 1042. The second electronic device 1020 transmits an emotion level corresponding to the input detected in step 1036 and information about the coordinates on which an emotion effect corresponding to the emotion level is displayed, to first electronic device 1010 through the sympathetic channel. Although the first electronic device 1010 is shown as only one electronic device, this is the only example, and a plurality of electronic devices may be provided.

The first electronic device 1010 receives an emotion level and information about the coordinates on which an emotion effect corresponding to the emotion level is displayed, from the second electronic device 1020 in step 1042. If an emotion level and information about the coordinates on which an emotion effect is displayed, are from the second electronic device 1020, the first electronic device 1010 displays an emotion effect corresponding to the emotion level at the point corresponding to the received coordinate information on the displayed content in step 1044. For example, upon receiving an emotion effect-applied sound, the first electronic device 1010 may play the received sound together with playback of the emotion effect. The first electronic device 1010 receives, in real time, an emotion level and information about the coordinates on which an emotion effect is displayed, in response to the input detected in step 1036. As described above, an electronic device transmits an emotion level and information about the coordinates on which an emotion effect is displayed, to the other electronic device in real time so that an emotion effect corresponding to an input detected in the electronic device may be displayed on the other electronic device.

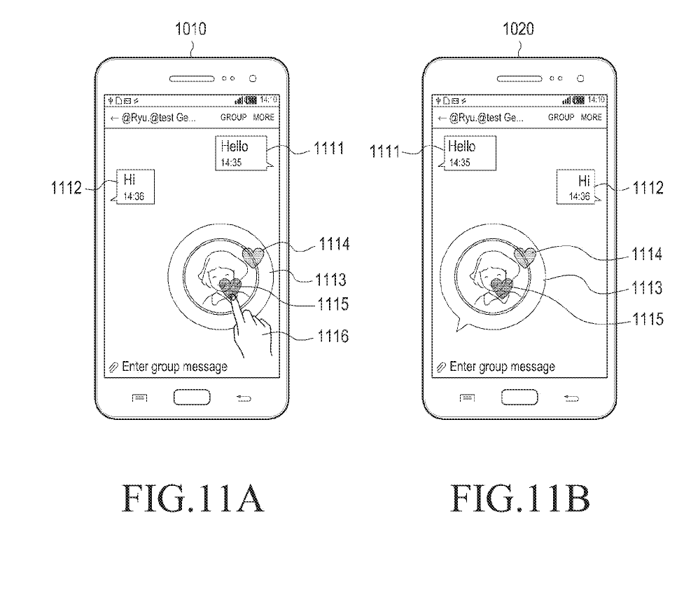

FIG. 11A illustrates a screen of a first electronic device according to embodiments of the present disclosure, and FIG. 11B illustrates a screen of a second electronic device according to embodiments of the present disclosure.

Referring to FIGS. 11A and 11B, if the first electronic device 1010 transmits a message 1111 to the second electronic device 1020, the second electronic device 1020 displays the message 1111 received from the first electronic device 1010. If the second electronic device 1020 transmits a response message 1112 for the received message 1111 to the first electronic device 1010, the first electronic device 1010 displays the response message 1112 received from the second electronic device 1020. As such, the first electronic device 1010 and the second electronic device 1020 transmit and receive messages to/from each other. The first electronic device 1010 transmits content 1113 to which an emotion effect 1114 is applied, to the second electronic device 1020, and the second electronic device 1020 displays the received content 1113.

When the emotion effect-applied content is transmitted and received between the first electronic device 1010 and the second electronic device 1020, a sympathetic channel may be connected between the first electronic device 1010 and the second electronic device 1020. If an input 1116 by at least one of a touch and hovering is detected on the displayed content 1113 while the sympathetic channel is connected, the first electronic device 1010 displays an emotion effect 1115 at the touched point. For the emotion effect 1115, its size may be enlarged or its color may be darkened, depending on the number of touches or the duration of the touch. If the touch 1116 occurs, the first electronic device 1010 transmits an emotion level by the touch 1116, an emotion effect corresponding to the emotion level, and information about the coordinates on which the emotion effect is displayed, to the second electronic device 1020. The first electronic device 1010 transmits at least one of an emotion level by the touch 1116, an emotion effect corresponding to the emotion level, and information about the coordinates on which the emotion effect is displayed, to the second electronic device 1020 in real time. The second electronic device 1020 may apply, onto the content 1113, an emotion level, an emotion effect corresponding to the emotion level and information about the coordinates on which the emotion effect is displayed, all of which are received from the first electronic device 1010. This operation may be performed in either the first electronic device 1010 or the second electronic device 1020. If the operation is performed in an electronic device, an emotion effect and information about the coordinates on which the emotion effect is displayed may be transmitted to other electronic device in real time, and the other electronic device displays the same emotion effect as the emotion effect displayed on the display of the electronic device that has detected an input.

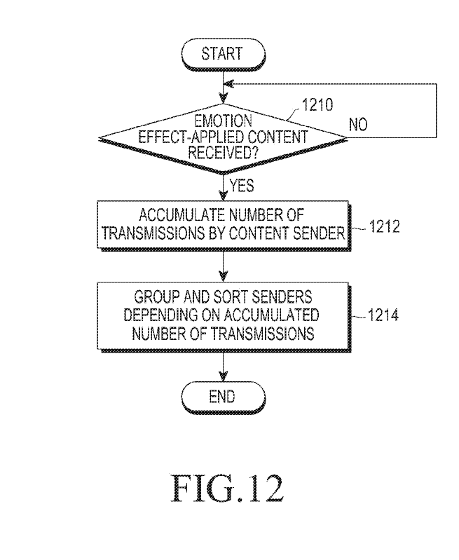

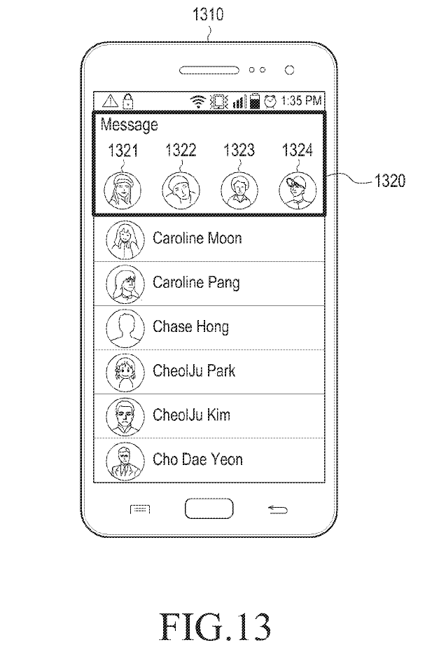

FIG. 12 illustrates a process of grouping senders who have sent emotion effect-applied content, according to embodiments of the present disclosure, and FIG. 13 illustrates the display of the grouped senders who have sent emotion effect-applied content, according to embodiments of the present disclosure.

A process of grouping senders who have sent emotion effect-applied content, according to embodiments of the present disclosure will be described in detail below with reference to FIGS. 12 and 13.

Upon receiving emotion effect-applied content in step 1210, an electronic device 1310 may accumulate the number of transmissions by the content sender in step 1212. Upon receiving content, the electronic device 1310 determines whether the received content include an emotion effect. Otherwise, upon receiving a message, the electronic device 1310 determines whether an emotion effect is applied to content included in the received message. For example, if an emotion effect is applied to the received content, the electronic device 1310 may store information, such as name, phone number, or photo regarding the sender of the content, content reception time, type of the emotion effect, emotion level of the emotion effect, the number of emotion effects, and information about the coordinates on which the emotion effect is displayed. The electronic device 1310 may accumulate or count the number of receptions for emotion effect-applied content for each sender. Otherwise, the electronic device 1310 may accumulate the number of receptions for each type of emotion effect.

The electronic device 1310 may group the senders depending on the accumulated number of transmissions in step 1214. The electronic device 1310 may group the senders by accumulating the number of transmissions by the senders who have sent the emotion effect-applied content. The electronic device 1310 may group the senders in the order of the sender who has sent more emotion effect-applied content. The electronic device 1310 may group the senders by accumulating the number of transmissions by the senders for each emotion effect, or in the order of the sender who has sent more content, for each emotion effect. The electronic device 1310 displays the grouped senders on the display, and displays information about the grouped senders in a partial area 1320 of the contact list. The area 1320 may be formed in any position of the display. The electronic device 1310 may sort the grouped at least one or more senders 1321, 1322, 1323 and 1324 in the partial area 1320 of the display in the order of the sender who has sent more emotion effect. For the sorted senders, their sort order may be changed depending on the number of transmissions for each emotion effect.

The term ‘module’ as used herein may refer to a unit that includes one or a combination of hardware, software or firmware. The term ‘module’ may be interchangeably used with terms such as unit, logic, logical block, component, or circuit. The ‘module’ may be the minimum unit of an integrally constructed part, or a part thereof. The ‘module’ may be the minimum unit for performing one or more functions, or a part thereof. The ‘module’ may be implemented mechanically or electronically. For example, the ‘module’ includes at least one of an application-specific integrated circuit (ASIC) chip, field-programmable gate arrays (FPGAs), or a programmable-logic device, which are known or will be developed in the future, and which perform certain operations.

At least a part of the apparatus or method according to embodiments of the present disclosure may, be implemented by an instruction that is stored in computer-readable storage media in the form of a program module. If the instruction is executed by at least one processor, the at least one processor performs a function corresponding to the instruction.

The computer-readable storage media includes magnetic media, such as a hard disk, a floppy disk, and magnetic tape, optical media, such as a compact disc read only memory (CD-ROM) and a digital versatile disc (DVD), magneto-optical media, such as a floptical disk, and a hardware device, such as a read only memory (ROM), a random access memory (RAM) or a flash memory. A program instruction includes not only a machine code such as a code made by a compiler, but also a high-level language code that can be executed by the computer using an interpreter. The above-described hardware device may be configured to operate as one or more software modules to perform the operations according to embodiments of the present disclosure, and vice versa.

According to embodiments, in a storage medium storing instructions, the instructions may be configured to allow at least one processor to perform at least one operation when the instructions are executed by the at least one processor, and the at least one operation includes an operation of executing a message application, an operation of, if content to be transmitted is selected, transmitting the selected content by using the executed message application, and an operation of displaying an emoticon replacing the transmitted content on the executed message application.

A module or a program module according to embodiments of the present disclosure may include at least one of the above-described components, some of which may be omitted, or may further include additional other components. Operations performed by a module, a program module or other components according to embodiments of the present disclosure may be performed in a sequential, parallel, iterative or heuristic way. Some operations may be performed in a different order or omitted, or other operations may be added. Embodiments disclosed herein have been presented for description and understanding of the technical details, but it is not intended to limit the scope of the present disclosure. Therefore, the scope of the present disclosure should be construed to include all changes or various other embodiments based on the technical spirit of the present disclosure.

As is apparent from the foregoing description, according to the present disclosure, a user may apply the user's emotion to the content while viewing the content, and transmit the emotion-applied content to other user, so the other user determines the emotion of the user who has sent the content, based on the received content.

According to the present disclosure, upon receiving emotion effect-applied content, an electronic device displays the emotion effect, so the user who has received the content may have a fluttering heart, and may infer the emotion of the user who has transmitted the content.

According to the present disclosure, a user connects a sympathetic channel for transmitting and receiving emotion effects, to the other party, making it possible to conveniently and easily express the user's emotions and exchange the emotion effects with the other party in real time.

While the present disclosure has been shown and described with reference to certain embodiments thereof, it will be understood by those skilled in the art that various changes in form and details may be made therein without departing from the spirit and scope of the disclosure as defined by the appended claims and their equivalents.

What is claimed is:

1. A method for transmitting and receiving content in an electronic device, the method comprising:
executing a message application;
transmitting, if content to be transmitted is selected, the selected content by using the executed message application; and
displaying an emoticon replacing the transmitted content on the executed message application.

2. The method of claim 1, further comprising:
replacing the displayed emoticon with the content in response to selection of the emoticon by a user of an electronic device that has received the content.

3. The method of claim 2, further comprising:
connecting a sympathetic channel to the electronic device that has received the content;
determining, if an input is detected while the content is displayed, an emotion level based on the detected input; and
applying an emotion effect corresponding to the determined emotion level onto the displayed content.

4. The method of claim 3, further comprising:
transmitting the emotion level and information about coordinates on which the emotion effect is displayed, to the electronic device that has received the content, through the connected sympathetic channel.

5. The method of claim 2, further comprising:
displaying, if an emotion level and information about coordinates on which the emotion effect is displayed are received from the electronic device that has received the content, the emotion effect corresponding to the emotion level at a point corresponding to the received coordinate information on the content.

6. The method of claim 3, wherein the detected input includes at least one of recognition of a face of a user viewing the displayed content and a touch on the displayed content.

7. The method of claim 6, wherein determining the emotion level comprises determining an emotion level of the user based on an expression degree of the recognized user face, or based on at least one of duration of the touch and the number of touches.

8. The method of claim 3, wherein the emotion level is determined based on at least one of recognition of a face of a user viewing the displayed content and a touch on the displayed content.

9. The method of claim 3, wherein the sympathetic channel transmits, in real time, an emotion effect of the user between the electronic device and the electronic device that has received the content.

10. A method for transmitting and receiving content in an electronic device, the method comprising:
receiving a message including content to which an emotion effect is applied;
displaying information about a sender who has sent the message and an emotion level of the emotion effect; and
displaying the emotion effect-applied content in response to a check of the received message.

11. The method of claim 10, further comprising executing an application for displaying the received message to display the received message.

12. The method of claim 11, wherein after the content was displayed, the application displays the received message after a lapse of a predetermined time.

13. The method of claim 10, wherein the emotion effect corresponds to an emotion level of the sender for the content.

14. The method of claim 10, further comprising:
accumulating the number of transmissions by the sender who has sent the message including the emotion effect-applied content; and
grouping senders depending on the accumulated number of transmissions.

15. The method of claim 14, wherein the senders are grouped in the order of the greater number of transmissions.

16. An electronic device for transmitting and receiving content, the electronic device comprising:
a display configured to display a message application; and
a controller configured to:
execute the message application;
transmit, if content to be transmitted is selected, the selected content by using the executed message application; and
display an emoticon replacing the transmitted content on the executed message application.

17. The electronic device of claim 16, wherein the controller is further configured to replace the displayed emoticon with the content in response to selection of the emoticon by a user of an electronic device that has received the content.

18. The electronic device of claim 16, further comprising a communication unit configured to connect a sympathetic channel to the electronic device that has received the content,
wherein the controller is configured to determine, if an input is detected while the content is displayed, an emotion level based on the detected input, apply an emotion effect corresponding to the determined emotion level onto the displayed content, and display the emotion effect-applied content on the display.

19. The electronic device of claim 18, wherein the controller is further configured to transmit the emotion level and information about coordinates on which the emotion effect is displayed, to the electronic device that has received the content, through the connected sympathetic channel.

20. The electronic device of claim 17, wherein the controller is further configured to display, if the emotion level and the information about coordinates on which the emotion effect is displayed are received from the electronic device that has received the content, an emotion effect corresponding to the emotion level at a point corresponding to the received coordinate information on the content.
